(19) United States
(12) Patent Application Publication
(10) Pub. No.: US 2026/0088741 A1
(43) Pub. Date: Mar. 26, 2026

(54) ELECTRIC POWER CONVERTER CONTROL DEVICE AND ELECTRIC POWER CONVERTER

(71) Applicant: Hitachi Astemo, Ltd., Hitachinaka-shi, Ibaraki (JP)

(72) Inventors: Manabu SEKIGUCHI, Hitachinaka-shi (JP); Takami SUZUKI, Hitachinaka-shi (JP); Kohei ONISHI, Hitachinaka-shi (JP)

(21) Appl. No.: 19/111,249

(22) PCT Filed: Nov. 30, 2022
(86) PCT No.: PCT/JP2022/044267

§ 371 Date: Mar. 12, 2025

(51) Int. Cl. H02P 21/22; H02P 21/20

(52) U.S. Cl. CPC H02P 21/22; H02P 21/20

(57) ABSTRACT

An electric power converter control device, which controls an electric power converter that performs electric power conversion between a direct current power supply and a motor, the electric power converter control device including: a magnetic flux command value generator configured to obtain a magnetic flux command value based on a torque command value; a current command value generator configured to obtain a current command value for controlling the motor, based on the torque command value and the magnetic flux command value; and a current command value adjuster configured to adjust the current command value based on the torque command value, a rotation detection value indicating a rotational speed of the motor, and a direct current voltage value indicating an output voltage of the direct current power supply.

### TECHNICAL FIELD

The present invention relates to an electric power converter control device and an electric power converter.

### BACKGROUND ART

A motor control device is known, which performs vector control of an alternating current motor based on a d-axis and a q-axis. The motor control device that performs the vector control generates a d-axis current command value id* and a q-axis current command value iq*, and controls the drive of the alternating current motor based on the d-axis current command value id* and the q-axis current command value iq*. For example, Patent Document 1 discloses a motor control method for an electric vehicle of performing the vector control as described above. In the motor control method for an electric vehicle disclosed in Patent Document 1, a magnetic flux command value is generated from a torque command value, and further, a current command value is obtained based on a map showing a relationship between the torque command value, the magnetic flux command value, and the current command values (d-axis current command value id* and q-axis current command value iq*).

### CITATION LIST

### Patent Documents

Patent Document 1: Japanese Patent No. 6192263

### SUMMARY OF INVENTION

### Technical Problem

However, in a motor actually mounted in a vehicle, a maximum torque per ampere (MTPA) line may change or a center point of a magnetic flux restriction circle may change in accordance with a change in a rotational speed of the motor or a change in an output voltage of a direct current electric power supply. That is, in the motor actually mounted in the vehicle, the response characteristics with respect to the torque command value change due to both the rotational speed and the output voltage of the direct current electric power supply. Therefore, in a case in which the current command value is obtained from a single map based on the torque command value and the magnetic flux command value as in Patent Document 1, a difference between the torque command value and the output torque may be large. Therefore, in the motor control method for an electric vehicle disclosed in Patent Document 1, it may be difficult to ensure the accuracy of the output torque with respect to the torque command value.

The present invention has been made in view of the above-described problems, and an object of the present invention is to improve accuracy of output torque with respect to a torque command value in a case of controlling a motor.

### Solution to Problem

The present invention employs the following configurations as means for solving the above-described object.

An aspect of the present invention employs a configuration of an electric power converter control device that controls an electric power converter that performs electric power conversion between a direct current electric power supply and a motor, the electric power converter control device including: a magnetic flux command value generation unit configured to obtain a magnetic flux command value based on a torque command value: a current command value generation unit configured to obtain a current command value for controlling the motor, based on the torque command value and the magnetic flux command value; and a current command value adjustment unit configured to adjust the current command value based on the torque command value, a rotation detection value indicating a rotational speed of the motor, and a direct current voltage value indicating an output voltage of the direct current electric power supply.

### Advantageous Effects of Invention

In the aspect of the present invention, the current command value generated by the current command value generation unit is adjusted by the current command value adjustment unit. The current command value adjustment unit adjusts the current command values based on the rotation detection value indicating the rotational speed of the motor and the direct current voltage value indicating the output voltage of the direct current electric power supply, in addition to the torque command value. Therefore, in the aspect of the present invention, it is possible to adjust the current command value in accordance with both the rotation detection value and the direct current voltage value. Therefore, in the present invention, even in a case in which the rotational speed of the motor and the direct current voltage value are changed, the difference between the torque command value and the output torque can be reduced, and the accuracy of the output torque with respect to the torque command value can be improved.

### BRIEF DESCRIPTION OF DRAWINGS

FIG. 1 A circuit diagram schematically showing the schematic configuration of a motor control device according to a first embodiment of the present invention.

FIG. 2 A block diagram showing the functional configuration of an electric power converter control device according to the first embodiment of the present invention.

FIG. 3 A block diagram showing the functional configuration of a torque control unit according to the first embodiment of the present invention.

FIG. 4 A block diagram showing the functional configuration of a magnetic flux command value generation unit according to the first embodiment of the present invention.

FIG. 5 A conceptual diagram of a current command value map according to the first embodiment of the present invention.

FIG. 6 A block diagram showing the functional configuration of a current command value adjustment unit according to the first embodiment of the present invention.

FIG. 7 A conceptual diagram of an adjustment value map according to the first embodiment of the present invention.

FIG. 8 A schematic diagram showing the operations and effects of the electric power converter control device according to the first embodiment of the present invention.

FIG. 9 A schematic diagram showing the operations and effects of the electric power converter control device according to the first embodiment of the present invention.

FIG. 10 A schematic diagram showing the operations and effects of the electric power converter control device according to the first embodiment of the present invention.

FIG. 11 A block diagram showing the functional configuration of an electric power converter control device according to a second embodiment of the present invention.

### DESCRIPTION OF EMBODIMENTS

Hereinafter, embodiments of an electric power converter control device and an electric power conversion device according to the present invention will be described with reference to the drawings.

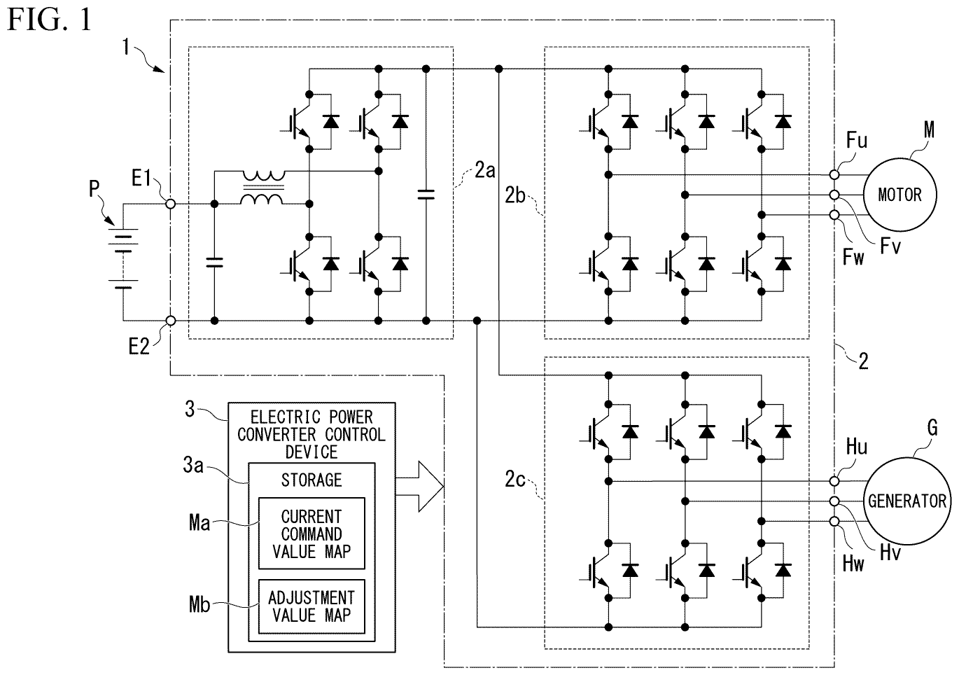

FIG. 1 is a circuit diagram schematically showing the schematic configuration of a motor control device 1 (electric power conversion device) according to the present embodiment. As shown in this figure, the motor control device 1 includes an electric power converter 2 and an electric power converter control device 3.

The electric power converter 2 is disposed between a motor M and a battery P (direct current electric power supply), and performs electric power conversion between the motor M and the battery P. As shown in FIG. 1, the electric power converter 2 includes a step-up/down converter 2a, a drive inverter 2b, and an electric power generation inverter 2c. The step-up/down converter 2a steps up a direct current voltage output from the battery P at a predetermined step-up ratio. In addition, the step-up/down converter 2a steps down a direct current voltage output from the drive inverter 2b or the electric power generation inverter 2c at a predetermined step-down ratio. As shown in FIG. 1, the step-up/down converter 2a includes, for example, a plurality of capacitors, a transformer, and a plurality of power semiconductor elements for voltage transformation. An insulated gate bipolar transistor (IGBT) or a metal oxide semiconductor field effect transistor (SiC-MOSFET) can be used as the power semiconductor element.

Such a step-up/down converter 2a is an electric power circuit known as a so-called magnetic coupling interleaved chopper circuit. The step-up/down converter 2a selectively performs a step-up operation of stepping up the direct current electric power input from the battery P via a pair of battery terminals and outputting the stepped-up direct current electric power to the drive inverter 2b, and a step-down operation of stepping down the direct current electric power input from the drive inverter 2b or the electric power generation inverter 2c and outputting the stepped-down direct current electric power to the battery P via the pair of battery terminals. That is, the step-up/down converter 2a is an electric power conversion circuit that inputs and outputs the direct current electric power bidirectionally between the battery P and the drive inverter 2b or the electric power generation inverter 2c.

The drive inverter 2b converts the direct current electric power output from the battery P into alternating current electric power based on a pulse width modulation (PWM) signal from the electric power converter control device 3 and supplies the alternating current electric power to the motor M. In addition, the drive inverter 2b converts the alternating current electric power output from the motor M into the direct current electric power based on the PWM signal from the electric power converter control device 3, and supplies the converted direct current electric power to the step-up/down converter 2a. As shown in FIG. 1, the drive inverter 2b has three switching legs and includes a total of six drive power semiconductor elements.

The drive inverter 2b includes three (plurality of) switching legs corresponding to the number of phases of the motor M. The drive inverter 2b is an electric power conversion circuit that selectively performs a powering operation and a regenerative operation. That is, the drive inverter 2b selectively performs the powering operation of converting the direct current electric power input from the step-up/down converter 2a into three-phase alternating current electric power and outputting the converted three-phase alternating current electric power to the motor M through three motor terminals, and the regenerative operation of converting the three-phase alternating current electric power input from the motor M through the three motor terminals into the direct current electric power and outputting the converted direct current electric power to the step-up/down converter 2a. That is, the drive inverter 2b is an electric power circuit that performs mutual conversion between the direct current electric power and the three-phase alternating current electric power between the step-up/down converter 2a and the motor M.

The electric power generation inverter 2c converts the alternating current electric power output from the generator G into the direct current electric power based on the PWM signal from the electric power converter control device 3 and supplies the converted direct current electric power to the step-up/down converter 2a. Such an electric power generation inverter 2c also has three switching legs and includes a total of six drive power semiconductor elements, similarly to the drive inverter 2b.

The electric power generation inverter 2c has three (plurality of) switching legs corresponding to the number of phases of the generator G. The electric power generation inverter 2c is an electric power conversion circuit that converts the three-phase alternating current electric power input from the generator G through three generator terminals into the direct current electric power and outputs the converted direct current electric power to the step-up/down converter 2a. That is, the electric power generation inverter 2c is an electric power circuit that performs mutual conversion between the direct current electric power and the three-phase alternating current electric power between the step-up/down converter 2a and the generator G.

As shown in the drawing, the battery P, the motor M, and the generator G are each connected to the electric power converter 2. The electric power converter 2 includes a pair of battery terminals (positive electrode battery terminal E1 and negative electrode battery terminal E2) to which the battery P is connected, as external connection terminals. In addition, the electric power converter 2 includes three motor terminals (U-phase motor terminal Fu, V-phase motor terminal Fv, and W-phase motor terminal Fw) to which the motor M is connected. In addition, the electric power converter 2 includes three generator terminals (U-phase generator terminal Hu, V-phase generator terminal Hv, and W-phase generator terminal Hw) to which the generator G is connected.

The motor control device 1 including such an electric power converter 2 is an electrical device provided in an electrified vehicle such as a hybrid vehicle or an electric vehicle, and controls the motor M that is a rotating machine and controls charging of the battery P with the alternating current electric power generated by the generator G. That is, the motor control device 1 performs drive control of the motor M based on the output (battery electric power) of the battery P and charge control of the battery P based on the output electric power (generated electric power) of the generator G.

It should be noted that the motor control device 1 can also be configured such that the electric power converter 2 does not include the electric power generation inverter 2c and the generator G is not connected to the electric power converter 2. In this case, the motor control device 1 performs the drive control of the motor M based on the output (battery electric power) of the battery P without performing the charge control of the battery P based on the output electric power (generated electric power) of the generator G.

Here, in the battery P, as shown in the drawing, a positive electrode is connected to the positive electrode battery terminal E1, and a negative electrode is connected to the negative electrode battery terminal E2. The battery P is a secondary battery such as a lithium ion battery, discharges the direct current electric power to the motor control device 1, charges the direct current electric power via the motor control device 1.

The motor M is a three-phase motor having “three” phases, and is a load of the drive inverter 2b. In this motor M, a U-phase input terminal is connected to the U-phase motor terminal Fu, a V-phase input terminal is connected to the V-phase motor terminal Fv, and a W-phase input terminal is connected to the W-phase motor terminal Fw. In such a motor M, a rotation shaft (drive shaft) is connected to wheels of the electrified vehicle, and the wheels are rotationally driven by applying rotational power to the wheels.

The generator G is a three-phase generator, and a U-phase output terminal is connected to the U-phase generator terminal Hu, a V-phase output terminal is connected to the V-phase generator terminal Hv, and a W-phase output terminal is connected to the W-phase generator terminal Hw. The generator G is connected to an output shaft of a power source such as an engine or the like mounted in the electrified vehicle, and outputs the three-phase alternating current electric power to the motor control device 1.

The electric power converter control device 3 includes a gate driver or an electronic control unit (ECU). The gate driver is a circuit that generates a gate signal based on various Duty command values (voltage transformation Duty command value, drive Duty command value, and electric power generation Duty command value) input from the ECU. For example, the gate driver generates a gate signal to be supplied to the step-up/down converter 2a based on the voltage transformation Duty command value input from the ECU. In addition, the gate driver generates a gate signal to be supplied to the drive inverter 2b based on the drive Duty command value input from the ECU. In addition, the gate driver generates a gate signal to be supplied to the electric power generation inverter 2c based on the electric power generation Duty command value input from the ECU.

The ECU is a control circuit that performs predetermined control processing based on a control program stored in advance. The ECU outputs various Duty command values (voltage transformation Duty command value, drive Duty command value, and electric power generation Duty command value) generated based on the control processing to the gate driver. Such an ECU performs the drive control of the motor M and the charge control of the battery P via the electric power converter 2 and the gate driver. That is, the ECU generates various Duty command values (voltage transformation Duty command value, drive Duty command value, and electric power generation Duty command value) related to the step-up/down converter 2a, the drive inverter 2b, and the electric power generation inverter 2c based on a detection value (voltage detection value) of a voltage sensor and a detection value (current detection value) of a current sensor, which are additionally provided in the step-up/down converter 2a, the drive inverter 2b, and the electric power generation inverter 2c, the operation information of the electrified vehicle, and the like.

In addition, as shown in FIG. 1, the electric power converter control device 3 includes a storage 3a. The storage 3a stores the above-described control program and various types of data. In the present embodiment, as shown in FIG. 1, the storage 3a stores a current command value map Ma. The current command value map Ma is a map used in a case in which the electric power converter control device 3 obtains a current command value for controlling the motor M. The current command value map Ma will be described in detail below.

In addition, the storage unit 3a stores an adjustment value map Mb. The adjustment value map Mb is a map used in a case in which an adjustment value for adjusting the current command value is set.

The adjustment value map Mb will also be described in detail below.

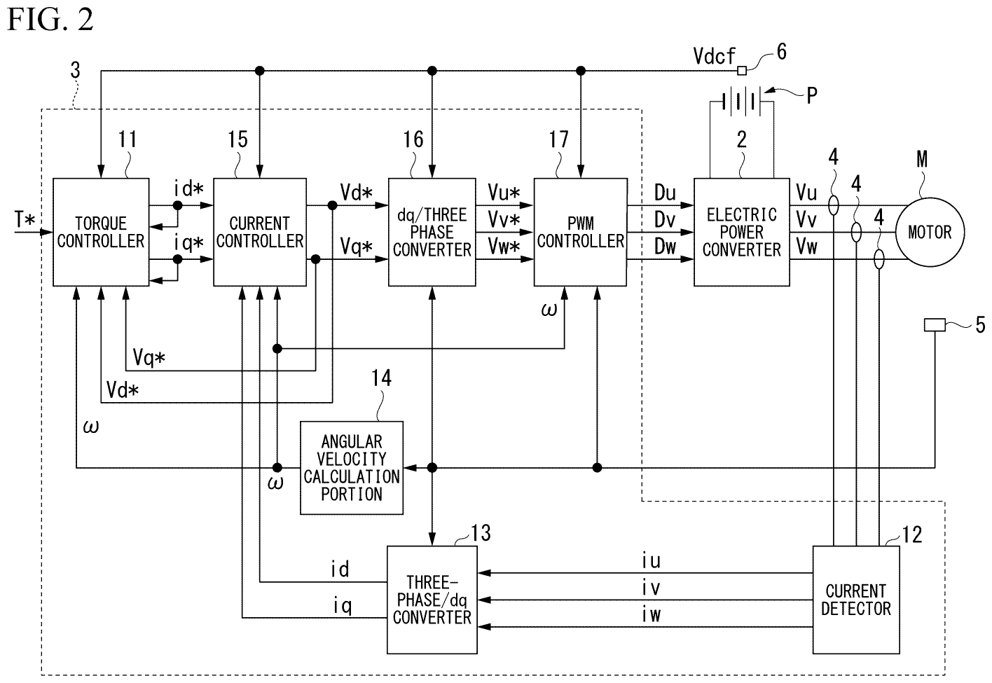

FIG. 2 is a block diagram showing a functional configuration of the electric power converter control device 3. The motor control device 1 includes a current sensor 4, a rotation angle sensor 5, and a voltage sensor 6, in addition to the electric power converter 2 and the electric power converter control device 3 as shown in FIG. 2.

The current sensor 4 detects each phase current between the motor M and the electric power converter 2, and outputs a detection result to the electric power converter control device 3. It should be noted that a plurality of current sensors 4 may be provided between the electric power converter 2 and the motor M, or may be provided inside the electric power converter 2. The current sensor 4 is not particularly limited as long as the current sensor 4 is configured to detect a phase current of each phase, and for example, includes a current transformer (CT) including a transformer or a Hall element. Further, the current sensor 4 may be a shunt resistor.

The rotation angle sensor 5 detects a rotation angle of the motor M. The rotation angle of the motor M is an electrical angle of the above-described rotor from a predetermined reference rotation position. The rotation angle sensor 5 outputs a detection signal indicating the detected rotation angle to the electric power converter control device 3. For example, the rotation angle sensor 5 may include a resolver. It should be noted that the rotational speed (motor rotational speed) of the motor M can be calculated based on the detection signal output from the rotation angle sensor 5. That is, the rotation angle sensor 5 outputs a detection signal including the motor rotational speed as information.

The voltage sensor 6 detects an output voltage of the battery P. In FIG. 2, the voltage sensor 6 is shown to be separated from the battery P, but, in practice, the voltage sensor 6 is connected to a wiring line connected to the battery P, and outputs a voltage value between the positive electrode and the negative electrode as a DC bus voltage value (direct current voltage detection value Vdcf). The direct current voltage detection value Vdcf is a direct current voltage value indicating the output voltage of the battery P that is the direct current electric power supply.

The electric power converter control device 3 includes, for example, a torque controller 11, a current detector 12, a three-phase/dq converter 13, an angular velocity calculation portion 14, a current controller 15, a dq/three-phase converter 16, and a PWM controller 17 as functional portions to be embodied by the gate driver, the ECU, or the like described above.

The torque controller 11 receives a pre-compensation torque command value T* from the outside. The torque controller 11 generates a d-axis current command value id* that is a target value of a d-axis current of the motor M and a q-axis current command value iq* that is a target value of a q-axis current of the motor M, based on the pre-compensation torque command value T*. Further, the torque controller 11 outputs the generated d-axis current command value id* and q-axis current command value iq* to the current controller 15.

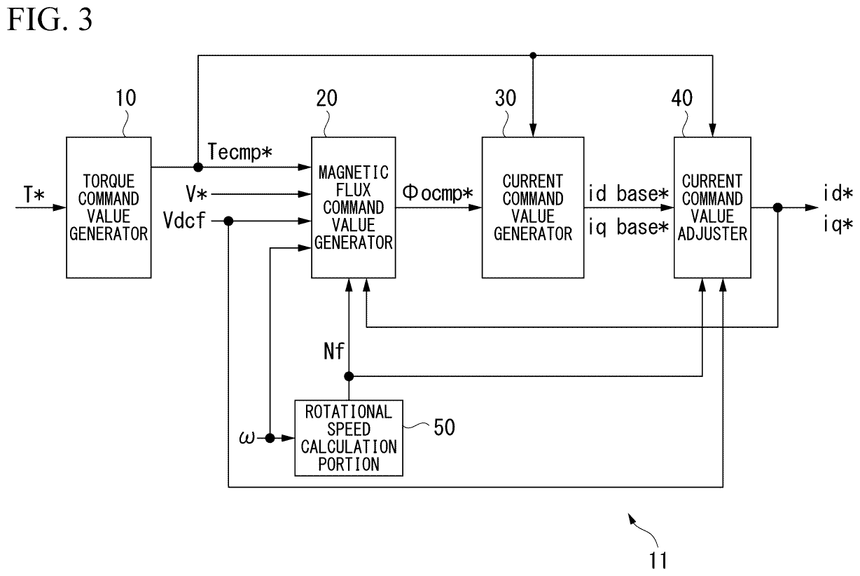

FIG. 3 is a block diagram showing a functional configuration of the torque controller 11. As shown this figure, in the present embodiment, the torque controller 11 includes a torque command value generation unit 10, a magnetic flux command value generation unit 20, a current command value generator 30, a current command value adjustment unit 40, and a rotational speed calculation unit 50.

The torque command value generator 10 generates a post-compensation torque command value Tecmp* from the pre-compensation torque command value T* based on a torque feedback value calculated based on a state of the motor M. It should be noted that the method of calculating the torque feedback value is not particularly limited. For example, the torque feedback value can be obtained based on a value indicating the state of the motor M (for example, a state of output torque or a state of a temperature) acquired by a detector (not shown). The post-compensation torque command value Tecmp* is a torque command value obtained by correcting the pre-compensation torque command value T* in accordance with an actual output torque based on the torque feedback value.

In the present embodiment, the post-compensation torque command value Tecmp* is input as the torque command value to the magnetic flux command value generator 20 or the current command value adjuster 40. However, it is not always necessary to generate the post-compensation torque command value Tecmp* from the pre-compensation torque command value T*. That is, the pre-compensation torque command value T* can also be input as the torque command value to the magnetic flux command value generator 20 or the current command value adjuster 40. In this case, it is also possible not to provide the torque command value generator 10.

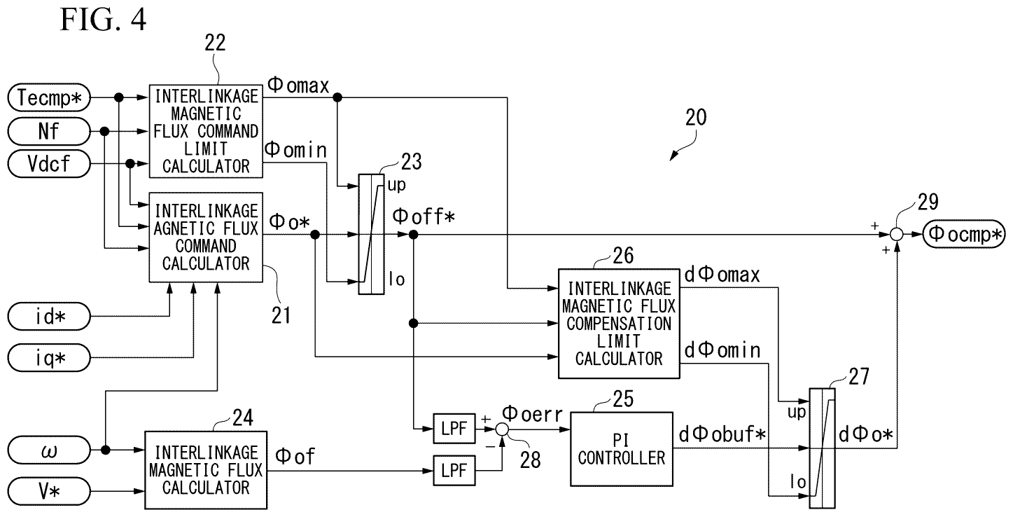

The magnetic flux command value generator 20 generates a magnetic flux command value (in the present embodiment, a post-compensation magnetic flux command value Φocmp* described below) based on the post-compensation torque command value Tecmp*. FIG. 4 is a block diagram of the magnetic flux command value generator 20. As shown this figure, the magnetic flux command value generator 20 includes an interlinkage magnetic flux command calculator 21, an interlinkage magnetic flux command limit calculator 22, an interlinkage magnetic flux command limit restriction portion 23, an interlinkage magnetic flux calculator 24, a PI controller 25, an interlinkage magnetic flux compensation limit calculator 26, and an interlinkage magnetic flux compensation limit restriction portion 27.

The interlinkage magnetic flux command calculator 21 calculates a pre-compensation interlinkage magnetic flux command value o* (pre-compensation magnetic flux command value) based on the post-compensation torque command value Tecmp*. For example, a motor rotational speed Nf (rotation detection value) indicating the rotational speed of the motor M is input to the interlinkage magnetic flux command calculator 21 from the rotational speed calculation portion 50 shown in FIG. 3. The motor rotational speed Nf is a value calculated by the rotational speed calculation portion 50 based on angular velocity ω as will be described below. Further, the angular velocity ω is calculated based on an output value of the rotation angle sensor 5. Therefore, the motor rotational speed Nf is the rotation detection value indicating the rotational speed of the motor M. Similarly, the angular velocity ω is also the rotation detection value indicating the rotational speed of the motor M.

Further, the direct current voltage detection value Vdcf is input to the interlinkage magnetic flux command calculator 21. For example, the interlinkage magnetic flux command calculator 21 obtains a modulation rate coefficient gmref to be used in the electric power converter 2 based on a map for obtaining the modulation rate coefficient gmref using the post-compensation torque command value Tecmp*, the motor rotational speed Nf, and the direct current voltage detection value Vdcf as parameters. Further, the interlinkage magnetic flux command calculator 21 calculates the pre-compensation interlinkage magnetic flux command value Φo* based on the modulation rate coefficient gmref, the motor rotational speed Nf, and the direct current voltage detection value Vdcf.

In addition, the interlinkage magnetic flux command calculator 21 calculates a magnetic flux estimation error as based on the modulation rate coefficient gmref, the post-compensation torque command value Tecmp*, the angular velocity ω, the direct current voltage detection value Vdcf, the d-axis current command value id* (current command value), the q-axis current command value iq* (current command value), and a minimum armature resistance value Ramin. Further, the interlinkage magnetic flux command calculator 21 obtains the pre-compensation interlinkage magnetic flux command value Φo* by using the magnetic flux estimation error ac.

Formula (1) is an example of a formula for calculating the magnetic flux estimation error αε. Further, Δεfx in Formula (1) can be calculated by, for example, Formula (2). Further, the pre-compensation interlinkage magnetic flux command value Φo* can be calculated by, for example, Formula (3). It should be noted that kv1ω in Formulas (1) and (3) is a value obtained by Formula (4). It should be noted that the minimum armature resistance value Ramin is stored in the storage 3a in advance, for example.

$$\begin{matrix}[ Formula 1 ] & \\ αε = - \frac{1}{2} Δ ε fx - \frac{1}{8} Δ ε {fx}^{2} & ( 1 )\end{matrix}$$

$$\begin{matrix}[ Formula 2 ] & \\ Δ ε fx = \frac{Ra min}{kv 1 {ω}^{2} {Vdcf}^{2}} [ 4 π \frac{Nf}{60} {Tecmp}^{*} + Ra min \{ {( {id}^{*} )}^{2} + {( {iq}^{*} )}^{2} \} ] & ( 2 )\end{matrix}$$

$$\begin{matrix}[ Formula 3 ] & \\ Φ {o}^{*} = \frac{kv 1 ω}{ω} ( 1 + αε ) Vdcf & ( 3 )\end{matrix}$$

$$\begin{matrix}[ Formula 4 ] & \\ kv 1 ω = gmref \times \frac{1}{\sqrt{2}} & ( 4 )\end{matrix}$$

For example, the interlinkage magnetic flux command calculator 21 calculates the magnetic flux estimation error as based on Formula (1) and Formula (2). In addition, the interlinkage magnetic flux command calculator 21 calculates the pre-compensation interlinkage magnetic flux command value Φo* based on Formula (3).

The interlinkage magnetic flux command limit calculator 22 calculates an interlinkage magnetic flux command upper limit value Φomax and an interlinkage magnetic flux command lower limit value Φomin based on the post-compensation torque command value Tecmp*, the motor rotational speed Nf, and the direct current voltage detection value Vdcf. The interlinkage magnetic flux command upper limit value Φomax (maximum interlinkage magnetic flux value) is a maximum interlinkage magnetic flux value that can be set for the post-compensation torque command value Tecmp* with the premise that field control can be performed. In addition, the interlinkage magnetic flux command lower limit value Φomin is a minimum interlinkage magnetic flux value that can be set for the post-compensation torque command value Tecmp* with the premise that the field control can be performed.

For example, the interlinkage magnetic flux command limit calculator 22 obtains the interlinkage magnetic flux command upper limit value Φomax based on an interlinkage magnetic flux restriction map for field control indicating the maximum value of the interlinkage magnetic flux command value for each value of the post-compensation torque command value Tecmp*. It should be noted that, as the interlinkage magnetic flux command lower limit value Φomin, a predetermined value may be used without calculation.

The interlinkage magnetic flux command limit restriction portion 23 restricts an upper limit value and a lower limit value of the pre-compensation interlinkage magnetic flux command value Φo* calculated by the interlinkage magnetic flux command calculator 21 based on the interlinkage magnetic flux command upper limit value Φomax and the interlinkage magnetic flux command lower limit value Φomin that are calculated by the interlinkage magnetic flux command limit calculator 22. That is, in a case in which the pre-compensation interlinkage magnetic flux command value Φo* input from the interlinkage magnetic flux command calculator 21 is larger than the interlinkage magnetic flux command upper limit value Φomax, the interlinkage magnetic flux command limit restriction unit 23 replaces a value of the pre-compensation interlinkage magnetic flux command value Φo* with a value of the interlinkage magnetic flux command upper limit value Φomax and outputs the replaced value. In addition, in a case in which the pre-compensation interlinkage magnetic flux command value Φo* input from the interlinkage magnetic flux command calculator 21 is smaller than the interlinkage magnetic flux command lower limit value Φomin, the interlinkage magnetic flux command limit restriction unit 23 replaces the value of the pre-compensation interlinkage magnetic flux command value Φo* with the value of the interlinkage magnetic flux command lower limit value Φomin and outputs the replaced value. It should be noted that the pre-compensation interlinkage magnetic flux command value Φo* output from the interlinkage magnetic flux command limit restriction portion 23 is referred to as a pre-compensation interlinkage magnetic flux command value Φoff*.

The interlinkage magnetic flux calculator 24 calculates an interlinkage magnetic flux feedback value Φof (magnetic flux feedback value) based on the angular velocity ω. For example, a voltage command value V* (d-axis voltage command value Vd* and q-axis voltage command value Vq*) is feedback-input to the interlinkage magnetic flux calculator 24 from the current controller 15 shown in FIG. 2. The interlinkage magnetic flux calculator 24 calculates the interlinkage magnetic flux feedback value of based on the angular velocity ω indicating a current motor rotational speed input from the angular velocity calculation portion 14 and a current voltage command value V* input from the current controller 15.

The PI controller 25 calculates a magnetic flux compensation value dΦobuf* based on a deviation Φoerr between the pre-compensation interlinkage magnetic flux command value Φoff* and the interlinkage magnetic flux feedback value Φof. The deviation Φoerr obtained by a subtractor 28 is input. The subtractor 28 calculates the deviation Φoerr by subtracting the interlinkage magnetic flux feedback value of input through a low-pass filter (LPF) from the pre-compensation interlinkage magnetic flux command value Φoff* input through the low-pass filter (LPF).

The PI controller 25 calculates the magnetic flux compensation value dΦobuf* by adding a value obtained by multiplying the deviation Φoerr with a proportional gain and a value obtained by multiplying the deviation Φoerr with an integral gain and then integrating the multiplied value. As described above, the PI controller 25 calculates the magnetic flux compensation value dΦobuf* based on the calculation using the proportional gain and the calculation using the integral gain.

It should be noted that a feedback-type anti-windup processing may be performed so that the integral term is not saturated. In this case, a value obtained by subtracting a magnetic flux compensation value dΦo* described below, which is output from the interlinkage magnetic flux compensation limit restriction unit 27, from the pre-compensation interlinkage magnetic flux command value Φoff* output from the PI controller 25 is obtained. In addition, calculation is performed in which a value obtained by multiplying the reciprocal of the proportional gain used in the PI controller 25 with respect to this value is subtracted from the deviation Φoerr, and then multiplied by the integral gain as described above.

The interlinkage magnetic flux compensation limit calculator 26 calculates a restriction value used in the interlinkage magnetic flux compensation limit restriction portion 27. Here, the interlinkage magnetic flux compensation limit restriction portion 27 calculates an upper restriction value dΦomax that restricts an upper limit value of the magnetic flux compensation value dΦobuf*. The calculated upper restriction value dΦomax is supplied to the interlinkage magnetic flux compensation limit restriction portion 27. In addition, the interlinkage magnetic flux compensation limit calculator 26 calculates a lower restriction value dΦomin that restricts a lower limit value of the magnetic flux compensation value dΦobuf*. The calculated lower restriction value dΦomin is supplied to the interlinkage magnetic flux compensation limit restriction portion 27.

For example, the interlinkage magnetic flux compensation limit calculator 26 calculates the upper restriction value dΦomax and the lower restriction value dΦomin based on the pre-compensation interlinkage magnetic flux command value Φo* input from the interlinkage magnetic flux command calculator 21 and the interlinkage magnetic flux command upper limit value Φomax input from the interlinkage magnetic flux command limit calculator 22.

The restriction of the magnetic flux compensation value dΦobuf* by the interlinkage magnetic flux compensation limit restriction portion 27, which will be described below, is useful in a case in which the motor M is subjected to field weakening control. In addition, in a case in which the pre-compensation interlinkage magnetic flux command value Φo* is smaller than the interlinkage magnetic flux command upper limit value Φomax, it can be determined that the field weakening control is required. Therefore, in a case in which the pre-compensation interlinkage magnetic flux command value o* is smaller than the interlinkage magnetic flux command upper limit value Φomax, the interlinkage magnetic flux compensation limit calculator 26 calculates the upper restriction value dΦomax and the lower restriction value dΦomin such that the upper limit value and the lower limit value of the magnetic flux compensation value dΦobuf* are restricted. That is, in a case in which the pre-compensation interlinkage magnetic flux command value o* is larger than the interlinkage magnetic flux command upper limit value Φomax and the field weakening control is not required, the interlinkage magnetic flux compensation limit calculator 26 sets the upper restriction value dΦomax and the lower restriction value dΦomin such that the upper limit value and the lower limit value of the magnetic flux compensation value dΦobuf* are zero.

It should be noted that the interlinkage magnetic flux compensation limit calculator 26 may calculate the upper restriction value dΦomax and the lower restriction value dΦomin by using the pre-compensation interlinkage magnetic flux command value Φoff* output from the interlinkage magnetic flux command limit restriction portion 23 instead of the pre-compensation interlinkage magnetic flux command value Φo*. In addition, the upper restriction value dΦomax and the lower restriction value dΦomin may be calculated by using the pre-compensation interlinkage magnetic flux command value Φo* and the pre-compensation interlinkage magnetic flux command value Φoff*.

The interlinkage magnetic flux compensation limit restriction portion 27 restricts the upper limit value and the lower limit value of the magnetic flux compensation value dΦobuf* based on the restriction value. Here, the interlinkage magnetic flux compensation limit restriction portion 27 restricts the upper limit value and the lower limit value of the magnetic flux compensation value dΦobuf* based on the upper restriction value dΦomax and the lower restriction value dΦomin input from the interlinkage magnetic flux compensation limit calculator 26.

That is, in a case in which the magnetic flux compensation value dΦobuf* input from the PI controller 25 is larger than the upper restriction value dΦomax, the interlinkage magnetic flux compensation limit restriction portion 27 replaces the value of the magnetic flux compensation value dΦobuf* with the upper restriction value dΦomax and outputs the replaced value. In addition, in a case in which the magnetic flux compensation value dΦobuf* input from the PI controller 25 is smaller than the lower restriction value dΦomin, the interlinkage magnetic flux compensation limit restriction portion 27 replaces the value of the magnetic flux compensation value dΦobuf* with the lower restriction value dΦomin and outputs the replaced value. It should be noted that the magnetic flux compensation value dΦobuf* output from the interlinkage magnetic flux compensation limit restriction portion 27 is referred to as the magnetic flux compensation value dΦo*.

In addition, as shown in FIG. 4, the magnetic flux command value generator 20 includes an adder 29 that adds the pre-compensation interlinkage magnetic flux command value Φoff* and the magnetic flux compensation value dΦo* and calculates the post-compensation magnetic flux command value Φocmp* to output the calculated post-compensation magnetic flux command value Φocmp*. That is, the adder 29 calculates the post-compensation magnetic flux command value Φocmp* from the pre-compensation interlinkage magnetic flux command value off* based on the magnetic flux compensation value dΦo*.

In the magnetic flux command value generation unit 20 configured as described above, the post-compensation torque command value Tecmp*, the motor rotational speed Nf, the angular velocity ω, and the direct current voltage detection value Vdcf are input to the interlinkage magnetic flux command calculator 21. In the interlinkage magnetic flux command calculator 21, the pre-compensation interlinkage magnetic flux command value Φo* is obtained based on the post-compensation torque command value Tecmp*, the motor rotational speed Nf, the angular velocity ω, and the direct current voltage detection value Vdcf.

Meanwhile, the post-compensation torque command value Tecmp*, the motor rotational speed Nf, and the direct current voltage detection value Vdcf are also input to the interlinkage magnetic flux command limit calculator 22. In the interlinkage magnetic flux command limit calculator 22, the interlinkage magnetic flux command upper limit value Φomax and the interlinkage magnetic flux command lower limit value Φomin are obtained based on the post-compensation torque command value Tecmp*, the motor rotational speed Nf, and the direct current voltage detection value Vdcf.

The pre-compensation interlinkage magnetic flux command value Φo* is restricted to a value based on the interlinkage magnetic flux command upper limit value Φomax or the interlinkage magnetic flux command lower limit value Φomin in the interlinkage magnetic flux command limit restriction portion 23 as necessary, and is output as the pre-compensation interlinkage magnetic flux command value Φoff*.

In addition, the angular velocity ω and the voltage command value V* are input to the interlinkage magnetic flux calculator 24. In the interlinkage magnetic flux calculator 24, the interlinkage magnetic flux feedback value of is calculated based on the angular velocity ω and the voltage command value V*.

The pre-compensation interlinkage magnetic flux command value Φoff* is input to the subtractor 28 via the low-pass filter. In addition, the interlinkage magnetic flux feedback value Φof is also input to the subtractor 28 via the low-pass filter. In the subtractor 28, the deviation Φoerr is calculated by subtracting the interlinkage magnetic flux feedback value Φof from the pre-compensation interlinkage magnetic flux command value Φoff*.

The deviation Φoerr is input to the PI controller 25. The PI controller 25 calculates the magnetic flux compensation value dΦobuf* by adding the value obtained by multiplying the deviation Φoerr with the proportional gain and the value obtained by multiplying the deviation Φoerr with the integral gain and then integrating the multiplied value.

Meanwhile, the pre-compensation interlinkage magnetic flux command value Φo* output from the interlinkage magnetic flux command calculator 21 and the interlinkage magnetic flux command upper limit value Φomax output from the interlinkage magnetic flux command limit calculator 22 are input to the interlinkage magnetic flux compensation limit calculator 26. In the interlinkage magnetic flux compensation limit calculator 26, the upper restriction value dΦomax, which restricts the upper limit value of the magnetic flux compensation value dΦobuf*, is calculated based on the pre-compensation interlinkage magnetic flux command value Φo* and the interlinkage magnetic flux command upper limit value Φomax. In addition, in the interlinkage magnetic flux compensation limit calculator 26, the lower restriction value dΦomin, which restricts the lower limit value of the magnetic flux compensation value dΦobuf*, is calculated based on the pre-compensation interlinkage magnetic flux command value Φo* and the interlinkage magnetic flux command upper limit value Φomax.

The magnetic flux compensation value dΦobuf* output from the PI controller 25 is restricted in the interlinkage magnetic flux compensation limit restriction portion 27 based on the upper restriction value dΦomax or the lower restriction value dΦomin as necessary, and is output as the magnetic flux compensation value dΦo*.

The pre-compensation interlinkage magnetic flux command value Φoff* output from the interlinkage magnetic flux command limit restriction portion 23 and the magnetic flux compensation value dΦo* output from the interlinkage magnetic flux compensation limit restriction portion 27 are input to the adder 29. In the adder 29, the pre-compensation interlinkage magnetic flux command value Φoff* and the magnetic flux compensation value dΦo* are added to calculate the post-compensation magnetic flux command value Φocmp*. The calculated post-compensation magnetic flux command value Φocmp* is input to the search direct current command value generator 30 shown in FIG. 3.

In the present embodiment, this post-compensation magnetic flux command value Φocmp* is input, as the magnetic flux command value, to the current command value generator 30. That is, in the present embodiment, the magnetic flux command value obtained by using the interlinkage magnetic flux feedback value of (magnetic flux feedback value) is input to the current command value generator 30. Therefore, the current command value generator 30 can obtain pre-adjustment current command values (pre-adjustment d-axis current command value idbase* and pre-adjustment q-axis current command value iqbase*) described below in a state in which the components caused by the interlinkage magnetic flux feedback value of are included. However, it is also possible to input the pre-compensation interlinkage magnetic flux command value Φoff*, as the magnetic flux command value, to the current command value generator 30.

The current command value generator 30 obtains the pre-adjustment d-axis current command value idbase* and the pre-adjustment q-axis current command value iqbase* based on the post-compensation torque command value Tecmp* and the post-compensation magnetic flux command value Φocmp*. Here, the current command value generator 30 obtains the pre-adjustment d-axis current command value idbase* and the pre-adjustment q-axis current command value iqbase* based on the current command value map Ma stored in the storage 3a.

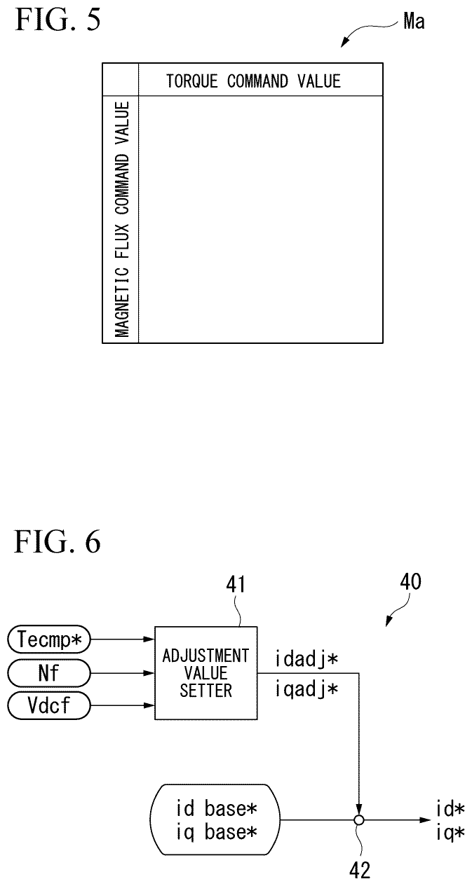

FIG. 5 is a conceptual diagram of the current command value map Ma. As shown in FIG. 5, the current command value map Ma is a two-dimensional map having the post-compensation torque command value Tecmp* and the post-compensation magnetic flux command value Φocmp* as parameters. In the current command value map Ma, the pre-adjustment d-axis current command value idbase* and the pre-compensation q-axis current command value iqbase* are associated with the post-compensation torque command value Tecmp* and the post-compensation magnetic flux command value Φocmp*. The current command value generator 30 obtains the pre-adjustment d-axis current command value idbase* and the pre-adjustment q-axis current command value iqbase* based on the post-compensation torque command value Tecmp* and the post-compensation magnetic flux command value Φocmp* with reference to the current command value map Ma.

The current command value adjuster 40 obtains the d-axis current command value id* and the q-axis current command value iq* by adjusting the d-axis current command value and the q-axis current command value before the adjustment (pre-adjustment d-axis current command value idbase* and pre-adjustment q-axis current command value iqbase*) based on the post-compensation torque command value Tecmp*, the motor rotational speed Nf, and the direct current voltage detection value Vdcf that are input. That is, in the present embodiment, the d-axis current command value id* and the q-axis current command value iq* are the d-axis current command value and the q-axis current command value that are adjusted by the current command value adjuster 40.

FIG. 6 is a block diagram showing a functional configuration of the current command value adjuster 40. As shown in this figure, the current command value adjuster 40 includes an adjustment value setter 41 and an adder 42 (adder-subtractor).

The adjustment value setter 41 sets the adjustment value based on the post-compensation torque command value Tecmp*, the motor rotational speed Nf, and the direct current voltage detection value Vdcf. The adjustment value setter 41 sets the adjustment value based on the post-compensation torque command value Tecmp*, the motor rotational speed Nf, and the direct current voltage detection value Vdcf with reference to an adjustment value map Mb stored in the storage unit.

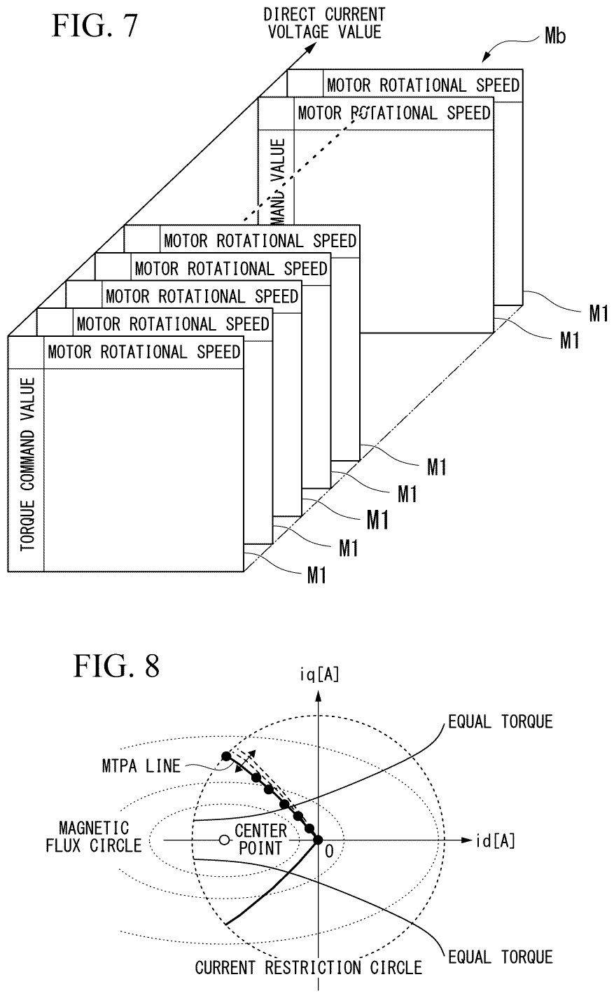

FIG. 7 is a conceptual diagram of the adjustment value map Mb. As shown in FIG. 7, the adjustment value map Mb is a three-dimensional map in which a plurality of two-dimensional maps M1 are provided in accordance with the direct current voltage value. For example, one two-dimensional map M1 is provided for each direct current voltage value of 1 V. It should be noted that the number of volts at which the two-dimensional map M1 is provided can be optionally changed for the direct current voltage value. Each two-dimensional map M1 is a map having the post-compensation torque command value Tecmp* and the motor rotational speed Nf as parameters. In addition, in each of the two-dimensional maps M1, the adjustment values (d-axis current adjustment value idadj* and q-axis current adjustment value iqadj*) are associated with the post-compensation torque command value Tecmp* and the motor rotational speed Nf. The adjustment value setter 41 sets the adjustment value based on the post-compensation torque command value Tecmp*, the motor rotational speed Nf, and the direct current voltage detection value Vdcf with reference to such an adjustment value map Mb.

It should be noted that such an adjustment value is determined in advance by an experiment or a simulation. Depending on the value of the post-compensation torque command value Tecmp*, the motor rotational speed Nf, or the direct current voltage detection value Vdcf, the d-axis current command value and the q-axis current command value need not be changed by adjustment. Therefore, the adjustment value that matches the condition in which the d-axis current command value and the q-axis current command value need not be changed by the adjustment is set to “0”. In a case in which the adjustment value is “0”, the values of the pre-adjustment d-axis current command value idbase* and the pre-adjustment q-axis current command value iqbase* are output from the current command value adjuster 40, without being changed by adjustment, as the d-axis current command value id* and the q-axis current command value iq*.

The adder 42 adds the adjustment value to the pre-adjustment d-axis current command value idbase* and the pre-adjustment q-axis current command value iqbase*. The adder 42 adds the d-axis current adjustment value idadj* to the pre-adjustment d-axis current command value idbase*.

Further, the adder 42 adds the q-axis current adjustment value iqadj* to the pre-adjustment q-axis current command value iqbase*. The d-axis current command value id* is obtained by adding the d-axis current adjustment value idadj* to the pre-adjustment d-axis current command value idbase*. The q-axis current command value iq* is obtained by adding the q-axis current adjustment value iqadj* to the pre-adjustment q-axis current command value iqbase*. It should be noted that the adjustment value may be set as a value subtracted from the pre-adjustment d-axis current command value idbase* and the pre-adjustment q-axis current command value iqbase*. In this case, a subtractor is provided instead of the adder 42.

The rotational speed calculation portion 50 calculates the motor rotational speed Nf from the angular velocity ω input from the angular velocity calculation portion 14. It should be noted that the rotational speed calculation portion 50 may calculate the motor rotational speed Nf from the electrical angle acquired from the rotation angle sensor 5. The rotational speed calculation portion 50 outputs the calculated motor rotational speed Nf to the magnetic flux command value generator 20 and the current command value adjuster 40.

It should be noted that, in the present embodiment, the torque controller 11 includes the rotational speed calculation portion 50. However, the rotational speed calculation portion 50 can be provided outside the torque controller 11. Further, it is also possible to change the motor rotational speed Nf, which is one of the parameters of the current command value map Ma, to the angular velocity ω. That is, the current command value map Ma need only be a map in which the rotation detection values indicating the rotational speed of the motor, such as the motor rotational speed Nf, the angular velocity, or the like, are used as parameters. For example, in a case in which the motor rotational speed Nf, which is one of the parameters of the current command value map Ma, is changed to the angular velocity ω, the motor rotational speed Nf, which is calculated by the rotational speed calculation portion 50, need not be input to the current command value adjuster 40.

Returning to FIG. 2, the current detector 12 detects a current value (hereinafter, referred to as a “U-phase current value”) iu flowing through a U-phase coil in the motor M, a current value (hereinafter, referred to as a “V-phase current value”) iv flowing through a V-phase coil in the motor M, and a current value (hereinafter, referred to as a “W-phase current value”) iw flowing through a W-phase coil in the motor M from the detection result of each current sensor 4. Then, the current detector 12 outputs the detected U-phase current value iu, V-phase current value iv, and W-phase current value iw to the three-phase/dq converter 13.

The three-phase/dq converter 13 converts the U-phase current value iu, the V-phase current value iv, and the W-phase current value iw, which are acquired from the current detector 12, into a d-axis current value id and a q-axis current value iq in a dq coordinate system by using the electrical angle acquired from the rotation angle sensor 5. The three-phase/dq converter 13 outputs the d-axis current value id and the q-axis current value iq to the current controller 15.

The angular velocity calculation portion 14 calculates the angular velocity ω (rotation detection value) based on the electrical angle of the motor M output from the rotation angle sensor 5. The angular velocity calculation portion 14 outputs the calculated angular velocity ω to the current controller 15. The current controller 15 calculates the d-axis voltage command value Vd* based on the d-axis current command value id*. The current controller 15 calculates the q-axis voltage command value Vq* based on the q-axis current command value iq*.

The current controller 15 outputs the d-axis voltage command value Vd* and the q-axis voltage command value Vq* to the dq/three-phase converter 16.

The dq/three-phase converter 16 acquires the electrical angle from the rotation angle sensor 5. The dq/three-phase converter 16 acquires the d-axis voltage command value Vd* and the q-axis voltage command value Vq* from the current controller 15. The dq/three-phase converter 16 converts the d-axis voltage command value Vd* and the q-axis voltage command value Vq* into a U-phase voltage command value Vu*, a V-phase voltage command value Vv*, and a W-phase voltage command value Vw*, which are the voltage command values of each phase of the UVW-phase in the motor M, by using the electrical angle. Then, the dq/three-phase converter 16 outputs the U-phase voltage command value Vu*, the V-phase voltage command value Vv*, and the W-phase voltage command value Vw* to the PWM controller 17. The U-phase voltage command value Vu*, the V-phase voltage command value Vv*, and the W-phase voltage command value Vw* are modulation waves, and may be referred to as “voltage command signals” in a case in which the U-phase voltage command value Vu*, the V-phase voltage command value Vv*, and the W-phase voltage command value Vw* are not distinguished from each other.

The PWM controller 17 compares a carrier wave having a predetermined carrier frequency with the voltage command signal. Then, the PWM controller 17 outputs the PWM signal to the electric power converter 2 by outputting a signal of a Hi level in a period in which the amplitude of the voltage command signal is larger than that of the carrier wave and outputting a signal of a Lo level in a period in which the amplitude of the voltage command signal is smaller than that of the carrier wave, as a result of the comparison. The PWM controller 17 generates the PWM signal Du by comparing the carrier wave with the U-phase voltage command value Vu*, and outputs the generated PWM signal Du to the electric power converter 2. The PWM controller 17 generates the PWM signal Dv by comparing the carrier wave with the V-phase voltage command value Vv*, and outputs the generated PWM signal Dv to the electric power converter 2. The PWM controller 17 generates the PWM signal Dw by comparing the carrier wave with the W-phase voltage command value Vw*, and outputs the generated PWM signal Dw to the electric power converter 2.

The electric power converter 2 is driven based on the PWM signals (PWM signal Du, PWM signal Dv, and PWM signal Dw, as described above) input from the PWM controller 17, to control the rotation of the motor M.

In the motor control device 1 according to the present embodiment, the torque command value generator 10 generates the post-compensation torque command value Tecmp* from the pre-compensation torque command value T* based on the torque feedback value. The post-compensation torque command value Tecmp* is input to the magnetic flux command value generator 20, the current command value generator 30, and the current command value adjuster 40. In the magnetic flux command value generator 20, the post-compensation magnetic flux command value Φocmp* is generated based on the post-compensation torque command value Tecmp*. The post-compensation magnetic flux command value Φocmp* is input to the current command value generator 30.

In the current command value generator 30, the pre-adjustment d-axis current command value idbase* and the pre-adjustment q-axis current command value iqbase* are obtained based on the post-compensation torque command value Tecmp* and the post-compensation magnetic flux command value Φocmp*. The pre-adjustment d-axis current command value idbase* and the pre-adjustment q-axis current command value iqbase* are input to the current command value adjuster 40. In the current command value adjuster 40, the d-axis current command value id* and the q-axis current command value iq* are obtained based on the post-compensation torque command value Tecmp*, the motor rotational speed Nf, and the direct current voltage detection value Vdcf.

The power converter control device 3 provided in the motor control device 1 according to the present embodiment as described above controls the power converter 2 that performs power conversion between the battery P and the motor M.

The power converter control device 3 according to the present embodiment includes the magnetic flux command value generator 20, the current command value generator 30, and the current command value adjuster 40. The magnetic flux command value generator 20 obtains the post-compensation magnetic flux command value Φocmp* based on the post-compensation torque command value Tecmp*. The current command value generator 30 obtains the current command values (pre-adjustment d-axis current command value idbase* and pre-adjustment q-axis current command value iqbase*) for controlling the motor M based on the post-compensation torque command value Tecmp* and the post-compensation magnetic flux command value Φocmp*. The current command value adjuster 40 adjusts the current command values (pre-adjustment d-axis current command value idbase* and pre-adjustment q-axis current command value iqbase*) based on the post-compensation torque command value Tecmp*, the motor rotational speed Nf indicating the rotational speed of the motor M, and the direct current voltage detection value Vdcf indicating the output voltage of the battery P.

As described above, the power converter control device 3 according to the present embodiment adjusts the current command values (pre-adjustment d-axis current command value idbase* and pre-adjustment q-axis current command value iqbase*), which are generated by the current command value generator 30, by the current command value adjuster 40. The current command value adjuster 40 adjusts the current command values based on the motor rotational speed Nf indicating the rotational speed of the motor M and the direct current voltage detection value Vdcf indicating the output voltage of the battery P, in addition to the post-compensation torque command value Tecmp*. Therefore, the power converter control device 3 according to the present embodiment can adjust the current command values in accordance with both the motor rotational speed Nf and the direct current voltage detection value Vdcf. Therefore, even in a case in which the rotational speed of the motor M and the direct current voltage detection value Vdcf are changed, the power converter control device 3 according to the present embodiment can reduce a difference between the post-compensation torque command value Tecmp* and the output torque, and can improve the accuracy of the output torque with respect to the post-compensation torque command value Tecmp*.

In addition, for example, in a case in which the post-compensation torque command value Tecmp* is a value between a plurality of values (lattice points) set in the current command value map Ma, linear interpolation can be performed to obtain the d-axis current command value id* and the q-axis current command value iq*. In this case, in a case in which the post-compensation torque command value Tecmp* is not a value obtained by linear interpolation of two lattice points (that is, in a case in which the post-compensation torque command value Tecmp* is not located at a position linearly connecting two lattice points), it is considered that the search for the point that converges in the magnetic flux feedback processing continues, and the d-axis current command value id* and the q-axis current command value iq* may not be able to be converged. In this case, the d-axis current command value id* and the q-axis current command value iq* are not stable and oscillate, and the output torque is not stable. On the other hand, with the power converter control device 3 according to the present embodiment, the d-axis current command value id* and the q-axis current command value iq* can be adjusted to converge by using the adjustment value, and the output torque can be stabilized.

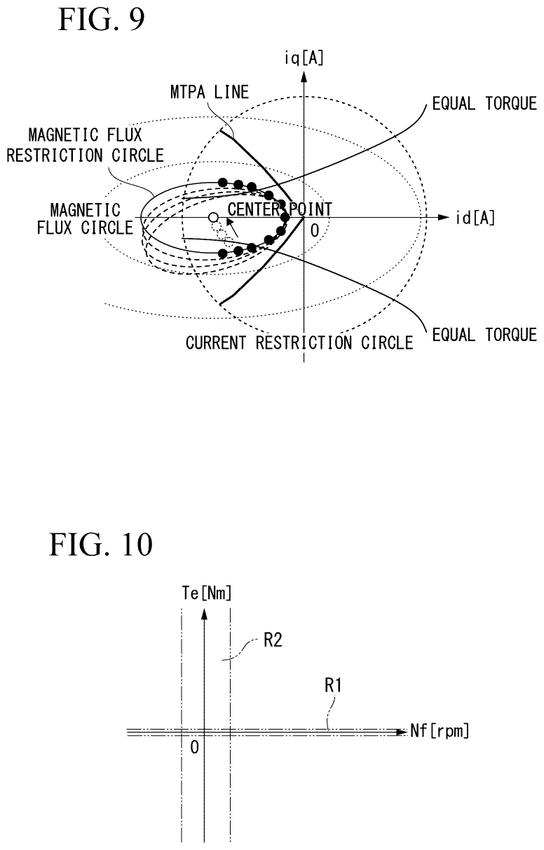

FIGS. 8 and 9 are schematic diagrams showing the operations and effects of the electric power converter control device 3 according to the present embodiment. FIGS. 8 and 9 are schematic diagrams showing transitions of a current operating point in an id-iq plane. For example, as shown in FIG. 8, in a case in which the motor Mis driven at the maximum output, the current operating point is changed along a minimum current maximum torque line (MTPA line) that has the highest efficiency. In a case in which, in the control, such a minimum current maximum torque line is set to be only one without depending on the motor rotational speed Nf and the output voltage of the battery P, the torque accuracy cannot be ensured in a case in which an actual minimum current maximum torque line is changed as shown by a broken line in FIG. 8 in accordance with the motor rotational speed Nf or the state of the output voltage of the battery P. On the other hand, in the electric power converter control device 3 according to the present embodiment, the minimum current maximum torque line can be set to be different in the control in accordance with the motor rotational speed Nf or the state of the output voltage of the battery P. Therefore, even in a case in which the motor rotational speed Nf or the output voltage of the battery P is changed, the torque accuracy can be ensured.

As shown in FIG. 9, in a case in which the motor M is controlled by the field weakening control, the current operating point is changed along a magnetic flux restriction circle. In a case in which the motor rotational speed Nf is low or the output voltage of the battery P is low, an actual position of the magnetic flux restriction circle changes as shown by a broken line in FIG. 9. In this case, in a case in which there is only one magnetic flux restriction circle on the control, the torque accuracy cannot be ensured in a case in which the actual magnetic flux restriction circle is changed as shown by a broken line in FIG. 9 in accordance with the motor rotational speed Nf or the state of the output voltage of the battery P. On the other hand, in the electric power converter control device 3 according to the present embodiment, the different magnetic flux restriction circles can be set in the control in accordance with the motor rotational speed Nf or the state of the output voltage of the battery P. Therefore, even in a case in which the motor rotational speed Nf or the output voltage of the battery P is low, the torque accuracy can be ensured.

FIG. 10 is a graph showing a relationship between the motor rotational speed Nf and actual output torque Te of the motor M. As shown in this figure, in a region R1 in which the output torque Te is close to 0 Nm, it is difficult to ensure the torque accuracy in a case of performing control using a single two-dimensional map in which the motor rotational speed and the magnetic flux command value are used as parameters.

As shown in FIG. 10, in a region R2 in which the motor rotational speed Nf is low, the torque command value generator 10 may obtain the torque command value without using the torque feedback value. In such a case, in a case in which the control is performed using a single two-dimensional map having the motor rotational speed and the magnetic flux command value as parameters, it is difficult to ensure the torque accuracy.

In the electric power converter control device 3 according to the present embodiment, even in the region R1 or the region R2 shown in FIG. 10, the different magnetic flux restriction circles can be set in the control in accordance with the motor rotational speed Nf or the state of the output voltage of the battery P. Therefore, even in the region R1 or the region R2 shown in FIG. 10, the torque accuracy can be ensured.

In addition, in the power converter control device 3 according to the present embodiment, the current command value adjuster 40 includes the adjustment value setter 41 and the adder 42. The adjustment value setter 41 sets the adjustment value based on the post-compensation torque command value Tecmp*, the motor rotational speed Nf, and the direct current voltage detection value Vdcf. The adder 42 adds the adjustment value to the current command value.

In the power converter control device 3 according to the present embodiment, the current command value can be adjusted by the calculation of only adding the adjustment value to the current command value. Therefore, the power converter control device 3 according to the present embodiment can ensure the torque accuracy while suppressing an amount of calculation.

In addition, the power converter control device 3 according to the above-described embodiment includes the storage 3a. The storage 3a stores the adjustment value map Mb showing a relationship between the post-compensation torque command value Tecmp*, the motor rotational speed Nf, and the direct current voltage detection value Vdcf and the adjustment value. Further, the adjustment value setter 41 sets the adjustment value based on the adjustment value map Mb.

The power converter control device 3 according to the present embodiment can easily set the adjustment value with reference to the adjustment value map Mb. Therefore, the power converter control device 3 according to the present embodiment can easily obtain the current command value.

For example, by using the adjustment value map Mb, for example, it is possible to finely set the adjustment value in a range in which the torque accuracy is likely to be reduced, and to roughly set the adjustment value in a range in which the torque accuracy is unlikely to be reduced. It should be noted that finely setting the adjustment value means setting a large number of adjustment values in the adjustment value map Mbc in a certain change range of the post-compensation torque command value Tecmp*, the motor rotational speed Nf, and the direct current voltage detection value Vdcf. As described above, the storage capacity of the adjustment value map Mb can be reduced by finely setting the adjustment value in a range in which the torque accuracy is likely to be reduced, rather than a range in which the torque accuracy is unlikely to be reduced. Accordingly, a storage region allocated to the adjustment value map Mb in the storage 3a can be reduced, and other data and the like can be stored in the storage 3a. For example, in vehicles in recent years, a storage capacity of the storage 3a is increased in order to support over-the-air (OTA: wireless program update function). The power converter control device 3 according to the present embodiment can store the adjustment value map Mb in the storage 3a even in such an OTA-compatible vehicle.

In addition, the power converter control device 3 according to the present embodiment includes the torque command value generator 10. The torque command value generator 10 can obtain the post-compensation torque command value Tecmp* by using the torque feedback value calculated based on the state of the motor M. Further, in a case in which the torque command value generator 10 obtains the post-compensation torque command value Tecmp* without using the torque feedback value, the current command value adjuster 40 changes the value of the current command value. As a result, even in a case in which the torque command value generator 10 obtains the post-compensation torque command value Tecmp* without using the torque feedback value, the torque accuracy can be ensured.

In addition, in the power converter control device 3 according to the present embodiment, the magnetic flux command value generator 20 obtains the post-compensation magnetic flux command value Φocmp* by using the magnetic flux feedback value calculated based on the state of the motor M. Therefore, the power converter control device 3 according to the present embodiment can obtain the current command value that reflects the interlinkage magnetic flux feedback value Φof. Therefore, the power converter control device 3 according to the present embodiment can further improve the torque accuracy.

In addition, the motor control device 1 according to the present embodiment includes the power converter 2 and the power converter control device 3. Therefore, the motor control device 1 according to the present embodiment can improve the torque accuracy with respect to the post-compensation torque command value Tecmp*.

### Second Embodiment

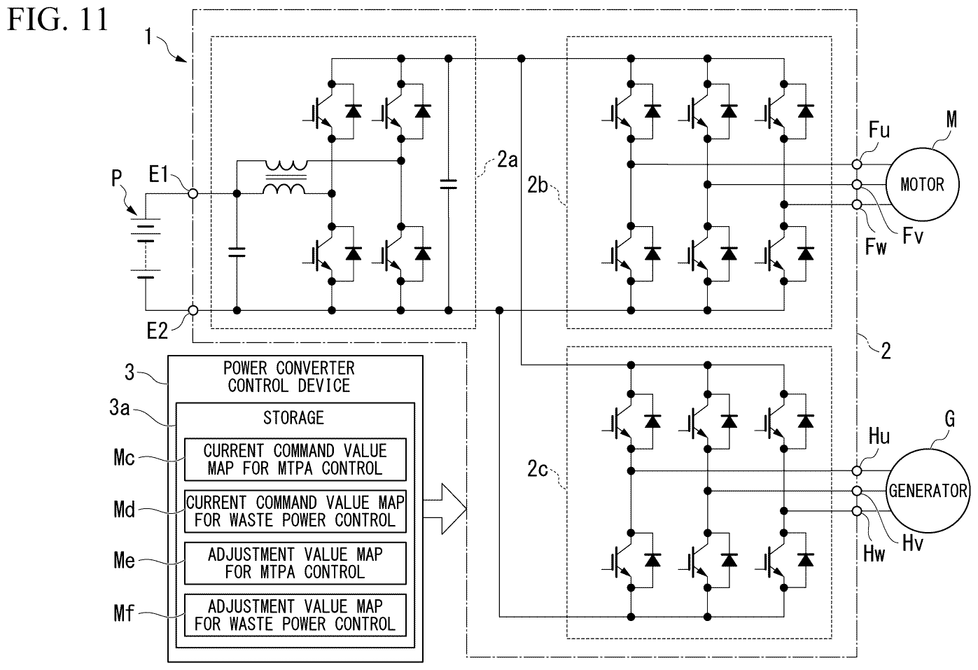

Hereinafter, a second embodiment of the present invention will be described with reference to FIG. 11. It should be noted that, in the description of the present embodiment, the description of the same parts as in the first embodiment will be omitted or simplified.

FIG. 11 is a schematic diagram of the power converter control device 3 according to the present embodiment.

As shown in this figure, in the power converter control device 3 according to the present embodiment, the storage 3a stores a current command value map for MTPA control Mc, a current command value map for waste power control Md, an adjustment value map for MTPA control Me, and an adjustment value map for waste power control Mf.

The current command value map for MTPA control Mc is the current command value map Ma used for obtaining the current command value in a case in which MTPA control (maximum torque/current control) is performed on the motor M. The current command value map for MTPA control Mc is a map in which the current command values (pre-adjustment d-axis current command value idbase* and pre-adjustment q-axis current command value iqbase*) based on the MTPA control are associated with the post-compensation torque command value Tecmp* and the post-compensation magnetic flux command value Φocmp*.

The current command value map for waste power control Md is the current command value map Ma used for obtaining the current command value in a case in which waste power control (field strengthening control) is performed on the motor M. The current command value map for waste power control Md is a map in which the current command values (pre-adjustment d-axis current command value idbase* and pre-adjustment q-axis current command value iqbase*) based on the waste power control are associated with the post-compensation torque command value Tecmp* and the post-compensation magnetic flux command value Φocmp*.

The adjustment value map for MTPA control Me is the adjustment value map Mb used for obtaining the adjustment value in a case in which the MTPA control is performed on the motor M. The adjustment value map for MTPA control Me is a map in which the adjustment values (d-axis current adjustment value idadj* and q-axis current adjustment value iqadj*) corresponding to the current command values based on the MTPA control are associated with the post-compensation torque command value Tecmp*, the motor rotational speed Nf, and the direct current voltage detection value Vdcf.

The adjustment value map for waste power control Mf is the adjustment value map Mb used for obtaining the adjustment value in a case in which the waste power control is performed on the motor M. The adjustment value map for waste power control Mf is a map in which the adjustment values (d-axis current adjustment value idadj* and q-axis current adjustment value iqadj*) corresponding to the current command values based on the waste power control are associated with the post-compensation torque command value Tecmp*, the motor rotational speed Nf, and the direct current voltage detection value Vdcf.

For example, the current command value generator 30 determines a control state of the motor M based on a signal input from the outside. Specifically, the current command value generator 30 determines whether the control state of the motor M is the MTPA control or the waste power control. In addition, the adjustment value setter 41 of the current command value adjuster 40 also determines whether the control state of the motor M is the MTPA control or the waste power control.

In a case in which the control state of the motor M is the MTPA control, the current command value generator 30 obtains the current command values (pre-adjustment d-axis current command value idbase* and pre-adjustment q-axis current command value iqbase*) with reference to the current command value map for MTPA control Mc. In addition, in a case in which the control state of the motor M is the MTPA control, the adjustment value setter 41 of the current command value adjuster 40 sets the adjustment values (d-axis current adjustment value idadj* and q-axis current adjustment value iqadj*) with reference to the adjustment value map for MTPA control Me.

Meanwhile, in a case in which the control state of the motor M is the waste power control, the current command value generator 30 obtains the current command values (pre-adjustment d-axis current command value idbase* and pre-adjustment q-axis current command value iqbase*) with reference to the current command value map for waste power control Md. In addition, in a case in which the control state of the motor M is the waste power control, the adjustment value setter 41 of the current command value adjuster 40 sets the adjustment values (d-axis current adjustment value idadj* and q-axis current adjustment value iqadj*) with reference to the adjustment value map for waste power control Mf.

In the power converter control device 3 according to the present embodiment as described above, the storage 3a stores the adjustment value map for MTPA control Me as the adjustment value map Mb used in a case in which the MTPA control is performed on the motor M. In addition, the adjustment value setter 41 sets the adjustment value based on the adjustment value map for MTPA control Me in a case in which the MTPA control is performed on the motor M. With the power converter control device 3 according to the present embodiment, the current command values (pre-adjustment d-axis current command value idbase* and pre-adjustment q-axis current command value iqbase*) can be adjusted by using the adjustment values suitable for the MTPA control.

In addition, in the power converter control device 3 according to the present embodiment, the storage 3a stores the adjustment value map for waste power control Mf as the adjustment value map Mb used in a case in which the waste power control is performed on the motor M. In addition, the adjustment value setter 41 sets the adjustment value based on the adjustment value map for waste power control Mf in a case in which the waste power control is performed on the motor M. With the power converter control device 3 according to the present embodiment, the current command values (pre-adjustment d-axis current command value idbase* and pre-adjustment q-axis current command value iqbase*) can be adjusted by using the adjustment values suitable for the waste power control.

As described above, with the power converter control device 3 according to the present embodiment, different current command values (pre-adjustment d-axis current command value idbase* and pre-adjustment q-axis current command value iqbase*) and different adjustment values (d-axis current adjustment value idadj* and q-axis current adjustment value iqadj*) are used depending on the control state of the motor M. Therefore, control suitable for each control state of the motor M can be performed.

The preferred embodiments of the present invention have been described above with reference to the accompanying drawings, but it goes without saying that the present invention is not limited to the above-described embodiments. The various shapes, combinations, and the like of the respective components shown in the above-described embodiments are merely examples, and can be variously changed based on design requirements and the like without departing from the gist of the present invention.

It should be noted that the above-described embodiments can also be described as, for example, the following supplementary notes.

### (Supplementary Note 1)

An electric power converter control device that controls an electric power converter that performs electric power conversion between a direct current power supply and a motor, the electric power converter control device including:
a magnetic flux command value generator configured to obtain a magnetic flux command value based on a torque command value;
a current command value generator configured to obtain a current command value for controlling the motor, based on the torque command value and the magnetic flux command value; and
a current command value adjuster configured to adjust the current command value based on the torque command value, a rotation detection value indicating a rotational speed of the motor, and a direct current voltage value indicating an output voltage of the direct current power supply.

### (Supplementary Note 2)

The electric power converter control device according to Supplementary Note 1, in which the current command value adjuster includes
an adjustment value setter configured to set an adjustment value based on the torque command value, the rotation detection value, and the direct current voltage value, and
an adder-subtractor configured to add or subtract the adjustment value to or from the current command value.

### (Supplementary Note 3)

The electric power converter control device according to Supplementary Note 2, further including:
a storage configured to store an adjustment value map showing a relationship between the torque command value, the rotation detection value, and the direct current voltage value and the adjustment value,
in which the adjustment value setter sets the adjustment value based on the adjustment value map.

### (Supplementary Note 4)

The electric power converter control device according to Supplementary Note 3,
in which the storage stores an adjustment value map for maximum torque/current control as the adjustment value map used in a case in which maximum torque/current control is performed on the motor, and
the adjustment value setter sets the adjustment value based on the adjustment value map for maximum torque/current control in a case in which the maximum torque/current control is performed on the motor.

### (Supplementary Note 5)

The electric power converter control device according to Supplementary Note 3 or 4,
in which the storage stores an adjustment value map for field strengthening control as the adjustment value map used in a case in which field strengthening control is performed on the motor, and
the adjustment value setter sets the adjustment value based on the adjustment value map for field strengthening control in a case in which the field strengthening control is performed on the motor.

### (Supplementary Note 6)

The electric power converter control device according to any one of Supplementary Notes 1 to 5, further including:
a torque command value generator configured to obtain the torque command value by using a torque feedback value calculated based on a state of the motor,
in which, in a case in which the torque command value generator obtains the torque command value without using the torque feedback value, the current command value adjuster changes a value of the current command value.

### (Supplementary Note 7)

The electric power converter control device according to any one of Supplementary Notes 1 to 6,
in which the magnetic flux command value generator obtains the magnetic flux command value by using a magnetic flux feedback value calculated based on a state of the motor.

### (Supplementary Note 8)

A electric power conversion device including:
the electric power converter; and
the electric power converter control device according to any one of Supplementary Notes 1 to 7.

### REFERENCE SIGNS LIST

1 Motor control device (electric power conversion device)
2 Electric power converter
3 Electric power converter control device
3a Storage
10 Torque command value generator
11 Torque controller
20 Magnetic flux command value generator
30 Current command value generator
40 Current command value adjuster
41 Adjustment value setter
42 Adder (adder-subtractor)
50 Rotational speed calculator

1. An electric power converter control device that controls an electric power converter that performs electric power conversion between a direct current power supply and a motor, the electric power converter control device comprising:
a magnetic flux command value generator configured to obtain a magnetic flux command value based on a torque command value;
a current command value generator configured to obtain a current command value for controlling the motor, based on the torque command value and the magnetic flux command value;
a current command value adjuster configured to adjust the current command value based on the torque command value, a rotation detection value indicating a rotational speed of the motor, and a direct current voltage value indicating an output voltage of the direct current power supply, and
a torque command value generator configured to obtain the torque command value by using a torque feedback value calculated based on a state of the motor,
wherein, in a case in which the torque command value generator obtains the torque command value without using the torque feedback value, the current command value adjuster changes a value of the current command value.

2. The electric power converter control device according to claim 1,
wherein the current command value adjuster includes
an adjustment value setter configured to set an adjustment value based on the torque command value, the rotation detection value, and the direct current voltage value, and
an adder-subtractor configured to add or subtract the adjustment value to or from the current command value.

3. The electric power converter control device according to claim 2, further comprising:
a storage configured to store an adjustment value map showing a relationship between the torque command value, the rotation detection value, and the direct current voltage value and the adjustment value,
wherein the adjustment value setter sets the adjustment value based on the adjustment value map.

4. The electric power converter control device according to claim 3,
wherein the storage stores an adjustment value map for maximum torque/current control as the adjustment value map used in a case in which maximum torque/current control is performed on the motor, and
the adjustment value setter sets the adjustment value based on the adjustment value map for maximum torque/current control in a case in which the maximum torque/current control is performed on the motor.

5. The electric power converter control device according to claim 3,
wherein the storage stores an adjustment value map for field strengthening control as the adjustment value map used in a case in which field strengthening control is performed on the motor, and
the adjustment value setter sets the adjustment value based on the adjustment value map for field strengthening control in a case in which the field strengthening control is performed on the motor.

6. (canceled)

7. The electric power converter control device according to claim 1,
wherein the magnetic flux command value generator obtains the magnetic flux command value by using a magnetic flux feedback value calculated based on a state of the motor.

8. An electric power conversion device comprising:
the electric power converter according; and
the electric power converter control device according to claim 1.
